(19) United States
(12) Patent Application Publication
(10) Pub. No.: US 2015/0027744 A1
(43) Pub. Date: Jan. 29, 2015

(54) VARIABLE MOMENT RESONANCE-FREE VIBRO HAMMER

(71) Applicant: Aydin Ozkan, Ankara (TR)

(72) Inventor: Aydin Ozkan, Ankara (TR)

(21) Appl. No.: 14/384,385

(22) PCT Filed: Mar. 30, 2012
(86) PCT No.: PCT/IB2012/051539

§ 371 Date: Sep. 10, 2014

(30) Foreign Application Priority Data
Mar. 15, 2012 (TR) 2012/02970

(51) Int. Cl. E02D 7/18; B06B 1/16

(52) U.S. Cl. CPC E02D 7/18; B06B 1/16
USPC 173/49

(57) ABSTRACT

The present invention relates to a vibro hammer; which is mounted on parts such as steel formed pipes and profiles and used in driving and extracting these parts to and from the soil, and is able to rotate without resonance; and which, by means of the transmission device whose main parts are the stepped shaft, toothed piston and transmission body, performs phase change between the upper weight set and lower weight set with fewer parts.

### FIELD OF THE INVENTION

The present invention relates to a vibro (vibratory) hammer used for driving and extraction of steel formed materials named sheet piles, profiles and steel pipes.

### BACKGROUND OF THE INVENTION

Vibro hammers are mounted on parts such as steel formed pipes and profiles, and have wide application in driving and extracting these parts to and from the soil. Vibro hammers drive pipes or profiles to soil by means of their eccentric weights.

There are four rotors in the vibration generation section provided in the vibro hammers. These rotors are arranged in two sets of two, one on top of the other (such that there will be one at each corner of a rectangle). There are semi cylindrical weights provided at each of these rotors. These weights generate vibrations of different intensities at different directions during rotation. In the case that the weights of the lower two rotors and those of the upper two rotors are at the same direction, vibrations are formed at the vibro hammer, whereas if they are at opposite directions, vibrations are not formed at the vibro hammer.

Adjustment of the weights at the same direction or opposite directions, in other words, the vibro hammer generating or not generating vibrations is enabled by a transmission device.

The U.S. Pat. No. 5,253,542, known in the state of the art, discloses a system which is comprised of two weights turning in opposite directions and wherein the lower weight part is coupled to the upper weight part by a transmission device. The said transmission device is comprised of two coaxial shafts each comprising helical teeth and a piston which slides between the two shafts, delimiting therewith at least one working chamber into which a pressurized hydraulic fluid is injected. In this system, the transmission device is comprised of two devices namely the first and second transmission device. In this system, where there is a plurality of devices, it is difficult to attain the same axis and the fact that the system is comprised of two devices causes it to get deformed more rapidly.

The United States patent document no. U.S.20020104393, known in the state of the art, discloses that the variable moment vibratory driver hydraulically shifts the phase of two sets of eccentric weights via a transmission device. It is one of the objectives of the invention to provide a variable moment vibratory driver which decreases vibrations. There are internal and external helical teeth on the transmission device but since the shaft within the transmission device is fixed by a ball bearing from a single side, the forces acting on the shaft cause the shaft to rapidly fail and to get deformed easily. Therefore this system has an unsound structure.

### SUMMARY OF THE INVENTION

The objective of the present invention is to provide a vibro hammer which has a long lasting transmission device by means of its single shaft and the ball bearings provided at both sides of the said shaft.

Another objective of the invention is to provide a vibro hammer which has a transmission device whose weights can be turned 180 degrees and this way enables generation of vibration in the system.

### DETAILED DESCRIPTION OF THE INVENTION

The vibro hammer developed to fulfill the objectives of the present invention is illustrated in the accompanying figures, in which

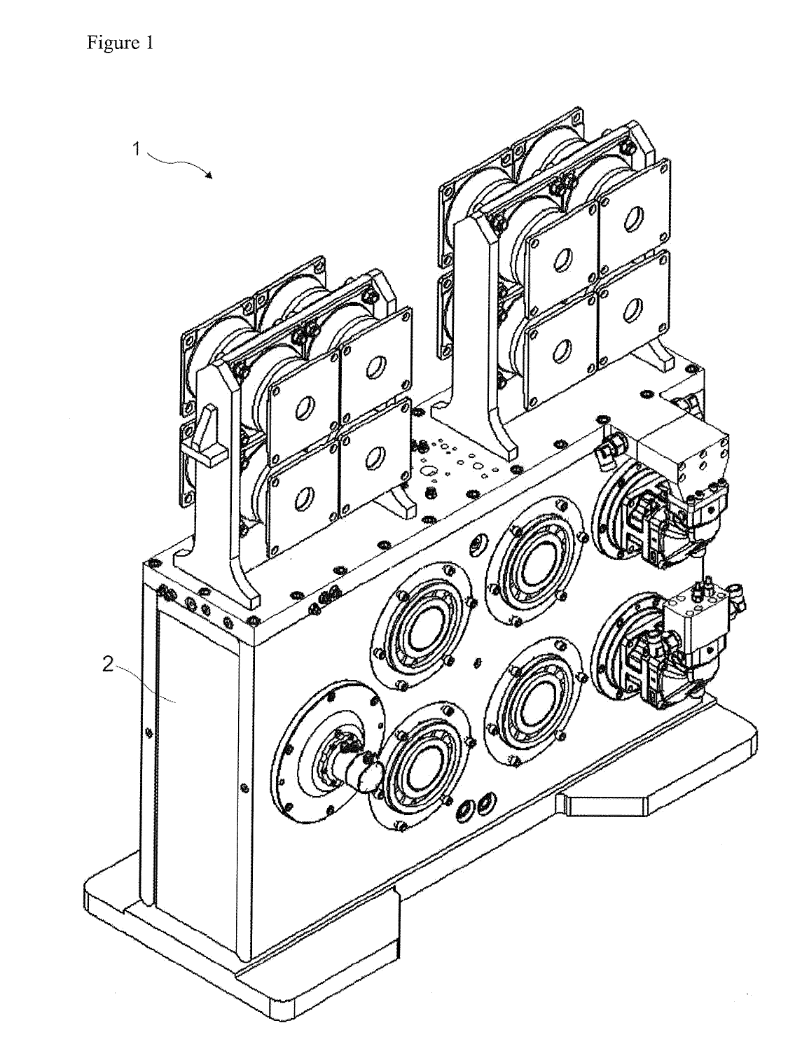

FIG. 1 is a perspective view of a vibro hammer.

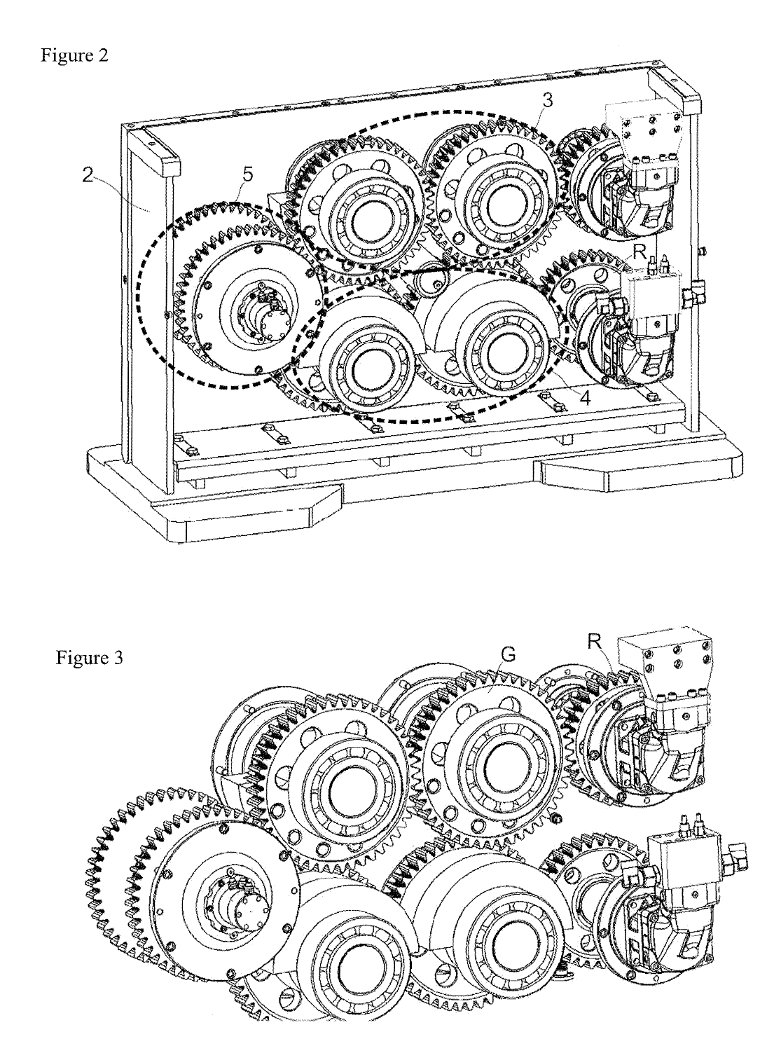

FIG. 2 is a perspective view of the main body.

FIG. 3 is a perspective view of the upper and lower weight sets, transmission device and hydromotor gear running within the main body, when the vibro hammer is operating in balance state.

FIG. 4 is a perspective view of the upper and lower weight sets, transmission device and hydromotor gear running within the main body, when the vibro hammer is operating in vibration state.

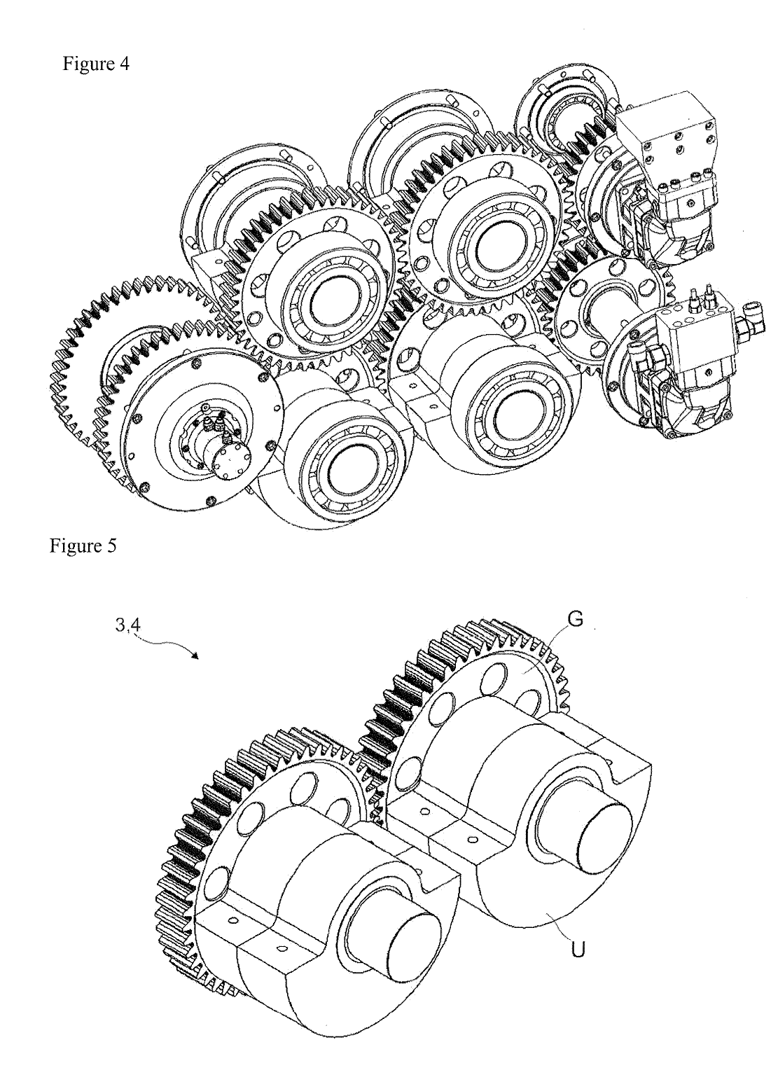

FIG. 5 is a perspective view of the upper and lower weight sets.

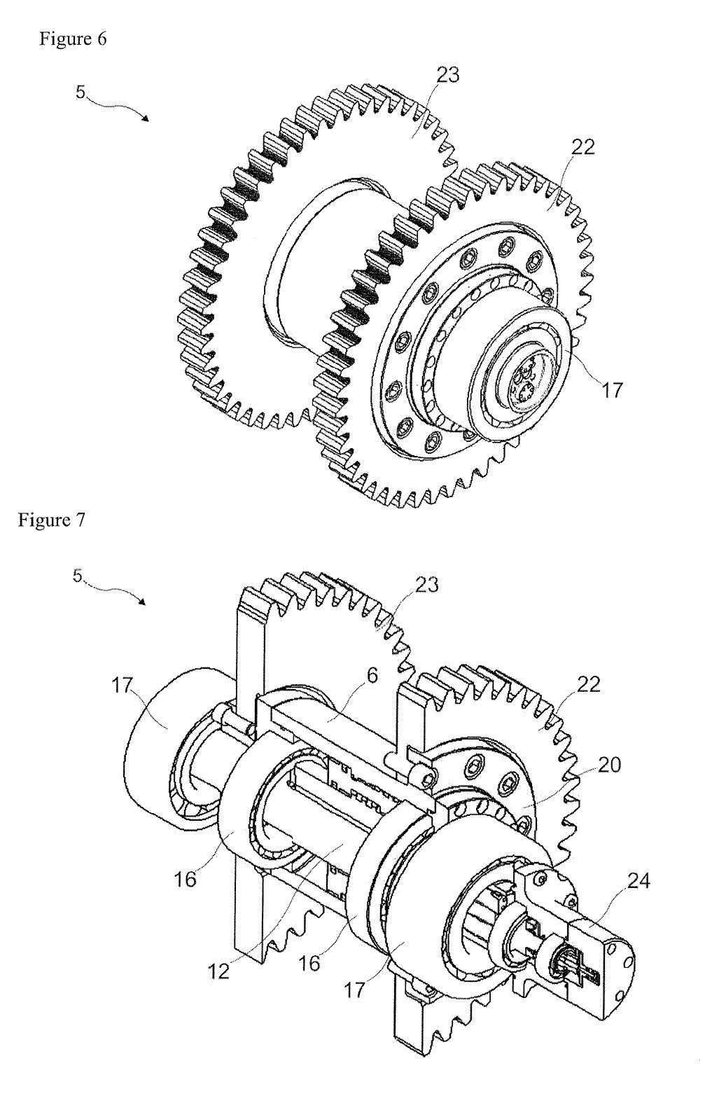

FIG. 6 is a perspective view of the transmission device.

FIG. 7 is a perspective view of a section of the transmission device.

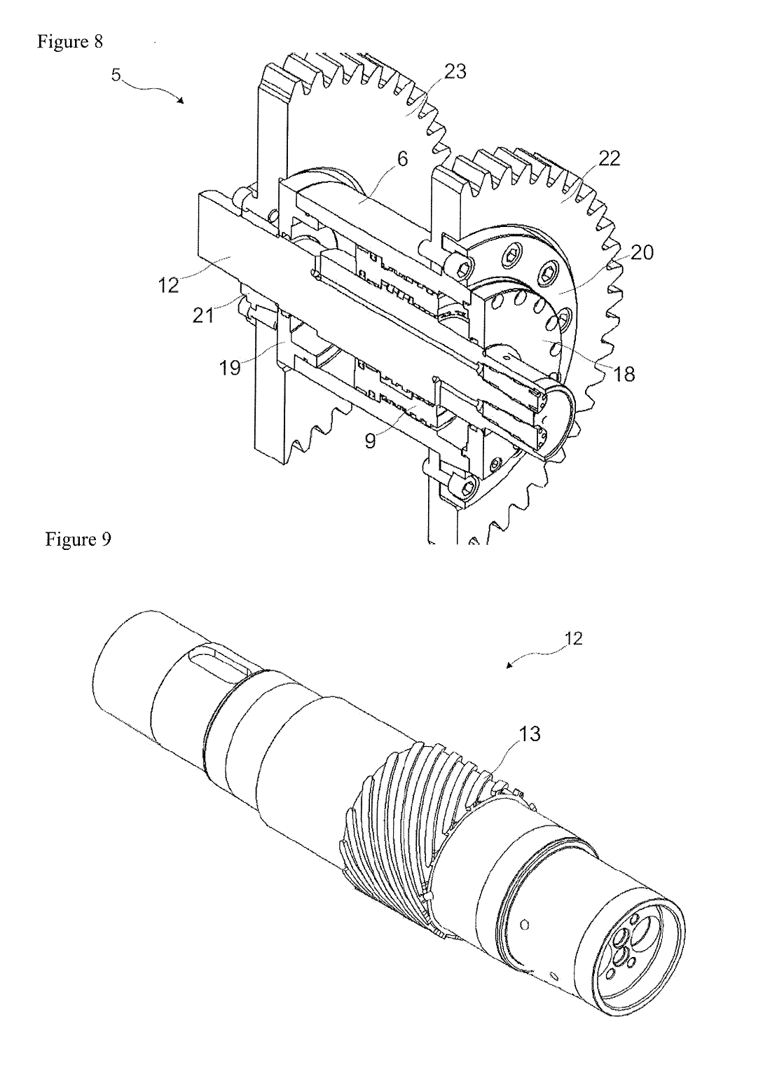

FIG. 8 is a perspective view of a section of the transmission device from another angle.

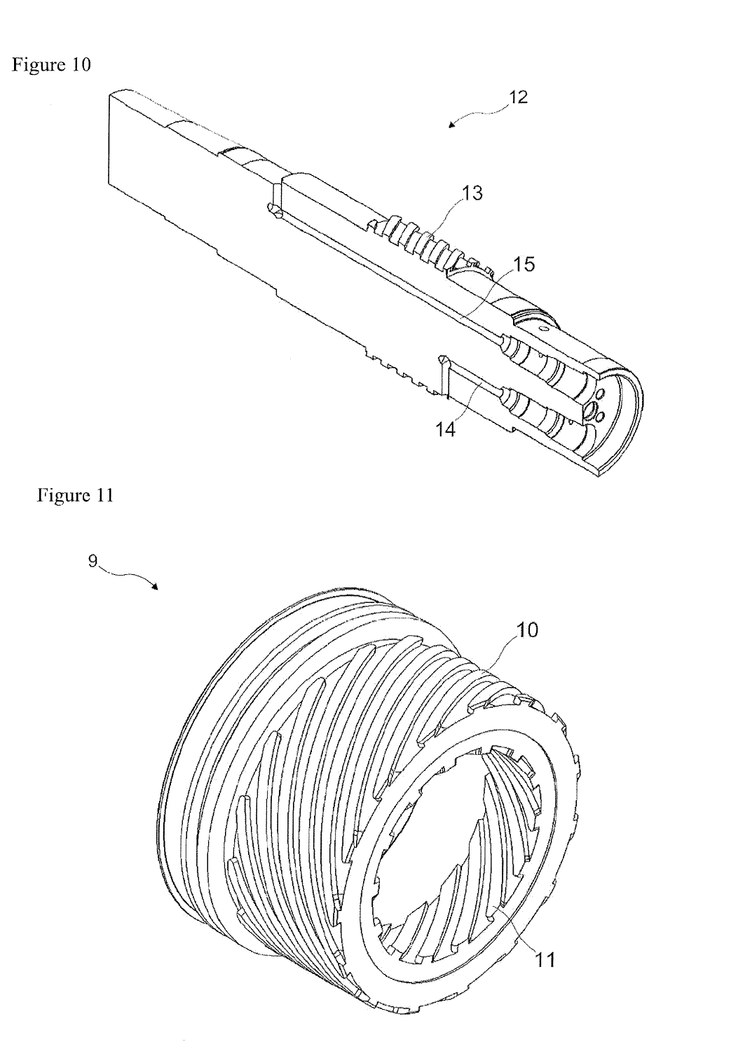

FIG. 9 is a perspective view of the stepped shaft.

FIG. 10 is a perspective view of a section of the stepped shaft.

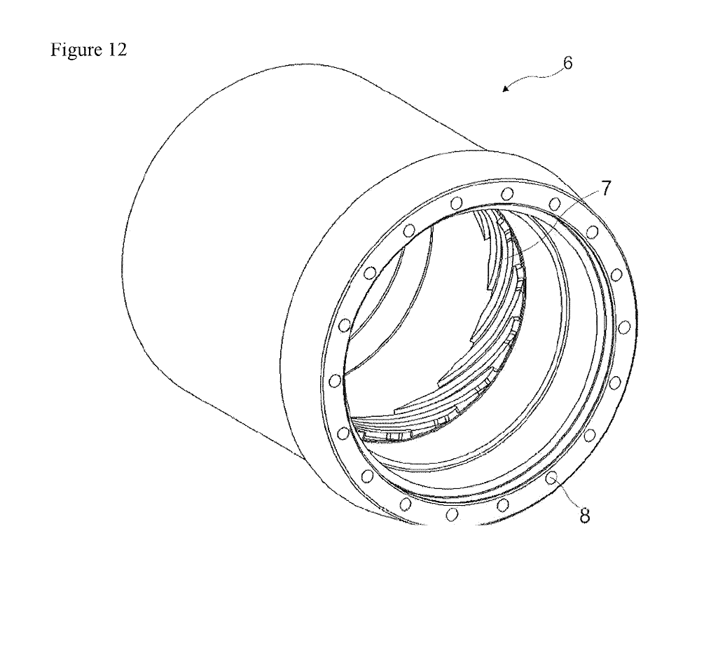

FIG. 11 is a perspective view of the toothed piston.

FIG. 12 is a perspective view of the transmission body.

The components shown in the figures are each given reference numerals as follows:

1. Vibro hammer

2. Main body

3. Upper weight set

4. Lower weight set

5. Transmission device

6. Transmission body

7. Body tooth

8. Body hole

9. Toothed piston

10. External tooth

11. Internal tooth

12. Stepped shaft

13. Shaft tooth

14. First oil line

15. Second oil line

16. First ball bearing

17. Second ball bearing

18. First cover

19. Second cover

20. First collar

21. Second collar

22. First gear

23. Second gear

24. Rotary oil delivery member

U. Weight

G. Set gear

R. Hydromotor gear

A vibro hammer (1); which is mounted on parts such as steel formed pipes and profiles, and used for driving or extracting these parts to or from the soil; and which is able to rotate without resonance; essentially comprises
at least one main body (2) which is placed on the profile that is driven in the soil,
at least one upper weight set (3) which is mounted to the main body (2) and enables the main body (2) to vibrate,
at least one lower weight set (4) which is closer to the profile driven into the soil than the upper weight set (3), and which is on the same axis with the upper weight set (3),
at least one transmission device (5) which enables or obstructs the main body (2) to or from generating vibration when desired by enabling synchronization between the upper weight set (3) and the lower weight set (4), and which, in addition, determines the intensity of the force that the main body (2) will apply on the profile,
at least one hollow transmission body (6) having a cylindrical geometry and a certain wall thickness,
at least one body tooth (7) which is provided in the inside of the transmission body (6) and along a certain length within the transmission body (6),
at least one body hole (8) provided on the wall thicknesses at both sides of the transmission body (6),
at least one hollow toothed piston (9) having a cylindrical geometry, which is placed at the area where the body tooth (7) is provided in the inside of the transmission body (6),
at least one external tooth (10) which is provided on the outer periphery of the toothed piston (9) and which operates synchronously with the body tooth (7),
at least one internal tooth (11) provided in the inside of the toothed piston (9),
a stepped shaft (12) which is passed through the hollow provided in the middle of the toothed piston (9) and which is a single piece located in the center of the transmission body (6),
at least one shaft tooth (13) which is provided at the part of the stepped shaft (12) that contacts the toothed piston (9) and which operates synchronously with the internal tooth (11),
at least one first oil line (14) that enables to transmit the pressure oil; which enables the toothed piston (9) located between the transmission body (6) and the stepped shaft (12) to move forward along the axis of the transmission body (6) so as to enable the stepped shaft (12) to rotate more; to the aperture between the stepped shaft (12) and the transmission body (6),
at least one second oil line (15) that enables to transmit the pressure oil; which enables the toothed piston (9) located between the transmission body (6) and the stepped shaft (12) to move backward along the axis of the transmission body (6) so as to enable the stepped shaft (12) to rotate less; to the aperture between the stepped shaft (12) and the transmission body (6),
at least one first ball bearing (16), whose inner ring is mounted to the stepped shaft (12) and whose outer ring is arranged on the transmission body (6), and which, thereby, enables the stepped shaft (12) to rotate within the transmission body (6),
at least one second ball bearing (17), whose inner ring is mounted to the stepped shaft (12) and whose outer ring is mounted to the main body (2), and which, thereby, enables the stepped shaft (12) to rotate connected to the main body (2),
at least one first cover (18) which is mounted to the body holes (8) provided on one side of the transmission body (6) via a bolt,
at least one second cover (19) which is mounted to the body holes (8) provided on the other side of the transmission body (6) via a bolt,
at least one first collar (20) whose diameter is somewhat larger than the diameter of the transmission body (6) and which is mounted to the transmission body (6) from the side that is close to the first cover (18),
at least one second collar (21) whose diameter is somewhat larger than the diameter of the stepped shaft (12) and which is mounted to the stepped shaft (12) from the side that is close to the second cover (19),
at least one first gear (22) which is mounted to the periphery of the transmission body (6) by means of the first collar (20) and which rotates at the same velocity with the rotation velocity of the transmission body (6),
at least one second gear (23) which is mounted to the stepped shaft (12) by means of the second collar (21) and which rotates at the same velocity with the rotation velocity of the stepped shaft (12),
at least one oil delivery member (24), which, when the stepped shaft (12) is desired to be rotated more or less, enables the aperture at the end of the first oil line (14) or the aperture at the end of the second oil line (15) to be filled with oil by injecting oil to the first oil line (14) or the second oil line (15), and which thus enables the toothed piston (9) to move.

In one embodiment of the invention, the stepped shaft (12) is mounted to the main body (2) by at least two second ball bearings (17). The second ball bearing (17) enables the stepped shaft (12) to rotate around its own axis. The toothed piston (9) is mounted to the area on the stepped shaft (12) where there is the shaft tooth (13). When the toothed piston (9) is mounted to the stepped shaft (12), the internal tooth (11) and the shaft tooth (13) are engaged to each other. The first ball bearing (16) located on the stepped shaft (12) enables the transmission body (6) to be kept around the stepped shaft (12). At the area where the transmission body (6) contacts the toothed piston (9), there is body tooth (7); and this tooth (7) is engaged with the external tooth (10). The first cover (18) is mounted to the side surface of the transmission body (6) that is close to the toothed piston (9) and the second cover (19) is mounted to the other side surface. The first gear (22) is mounted to the transmission body (6) by means of the first collar (20). The first gear (22) has the same angular velocity with the angular velocity of the transmission body (6), and rotates synchronously with the transmission body (6). The second gear (23) is mounted to the stepped shaft (12) by means of the second collar (21), and has the same angular velocity with the angular velocity of the stepped shaft (12).

The operation principle of the embodiment of the invention is defined as follows: the transmission device (5), all of whose above mentioned parts are connected, is mounted by means of the second ball bearing (17) to the holes provided therefor on the main body (2). After the mounting, the set gear (G) provided on the upper weight set (3) contacts the first gear (22), and the set gear (G) provided on the lower weight set (4) contacts the second gear (23). The upper weight set (3) and the lower weight set (4) are separately driven by the hydromotor gear (R), however two different hydromotor gears (R) rotate at the same velocity. In situations where the vibro hammer (1) has not started to operate, the outer surfaces of the semi-circular weight (U) having a certain wall thickness provided on the upper weight set (3) and of the weight (U) provided on the lower weight set (4) are at a position where they face each other (FIG. 3). When the vibro hammer (1) is driven this way, vibration is not formed at the main body (2) since the weights (U) at the sets (3, 4) balance each other when they are rotating, and the sets (3, 4) rotate in harmony at this position. The sets (3, 4) rotate this way in a balance state until a certain revolution at which the vibro hammer (1) generates resonance is exceeded. Due to the fact that the sets (3, 4) rotate at the same velocity and in balance state, the first gear (22) and the second gear (23) provided at the transmission device (5) rotate at the same velocity and the same direction. After the resonance risk is eliminated; by means of the rotary oil delivery member (24), pressure oil is delivered to the first oil line (14) and the aperture at the end of the first oil line (14) is filled with oil. By means of this oil, the toothed piston (9) moves a little along the axis of the stepped shaft (12). By means of this movement, the stepped shaft (12) rotates with an angular velocity which is a little more than the angular velocity at which the transmission body (6) rotates. Rotation of the stepped shaft (12) a little faster by means of the toothed piston (9) causes the second gear (23) to rotate a little faster as well, and this in turn causes the lower weight set (4) to rotate a little faster than the upper weight set (3). This relatively fast rotation enables the weights (U) at the lower weight set (4) to come to the same position with the weights (U) at the upper weight set (3) (FIG. 4). The two sets (3, 4) coming to the same position cause generation of force by vibration and this in turn causes the vibro hammer (1) to easily drive or extract profiles to or from the ground surface by vibration. After driving or extraction is performed, the rotary oil delivery member (24) this time fills the area at the end of the second oil line (15) with oil and thus the stepped shaft (12) moves a little slower in relation to the toothed piston (9) and this way the sets (3, 4) are brought from the vibration state to balance state.

It is possible to develop various embodiments of the inventive vibro hammer (1). The invention can not be limited to the examples described herein and it is essentially as defined in the claims.

1. A vibro hammer (1); which is mounted on parts such as steel formed pipes and profiles, and used for driving or extracting these parts to or from the soil; and which is able to rotate without resonance; essentially comprising
at least one main body (2) which is placed on the profile that is driven in the soil,
at least one upper weight set (3) which is mounted to the main body (2) and enables the main body (2) to vibrate,
at least one lower weight set (4) which is closer to the profile driven into the soil than the upper weight set (3), and which is on the same axis with the upper weight set (3),
at least one transmission device (5) which enables or obstructs the main body (2) to or from generating vibration when desired by enabling synchronization between the upper weight set (3) and the lower weight set (4), and which, in addition, determines the intensity of the force that the main body (2) will apply on the profile, and characterized by
at least one hollow transmission body (6) having a cylindrical geometry and a certain wall thickness,
at least one body tooth (7) which is provided in the inside of the transmission body (6) and along a certain length within the transmission body (6),
at least one hollow toothed piston (9) having a cylindrical geometry, which is placed at the area where the body tooth (7) is provided in the inside of the transmission body (6),
at least one external tooth (10) which is provided on the outer periphery of the toothed piston (9) and which operates synchronously with the body tooth (7),
at least one internal tooth (11) provided in the inside of the toothed piston (9),
a stepped shaft (12) which is passed through the hollow provided in the middle of the toothed piston (9) and which is a single piece located in the center of the transmission body (6),
at least one shaft tooth (13) which is provided at the part of the stepped shaft (12) that contacts the toothed piston (9) and which operates synchronously with the internal tooth (11),
at least one first oil line (14) that enables to transmit the pressure oil; which enables the toothed piston (9) located between the transmission body (6) and the stepped shaft (12) to move forward along the axis of the transmission body (6) so as to enable the stepped shaft (12) to rotate more; to the aperture between the stepped shaft (12) and the transmission body (6),
at least one second oil line (15) that enables to transmit the pressure oil; which enables the toothed piston (9) located between the transmission body (6) and the stepped shaft (12) to move backward along the axis of the transmission body (6) so as to enable the stepped shaft (12) to rotate less; to the aperture between the stepped shaft (12) and the transmission body (6).

2. A vibro hammer (1) according to claim 1, characterized by at least one first ball bearing (16), whose inner ring is mounted to the stepped shaft (12) and whose outer ring is arranged on the transmission body (6), and which, thereby, enables the stepped shaft (12) to rotate within the transmission body (6).

3. A vibro hammer (1) according to claim 1, characterized by at least one second ball bearing (17), whose inner ring is mounted to the stepped shaft (12) and whose outer ring is mounted to the main body (2), and which, thereby, enables the stepped shaft (12) to rotate connected to the main body (2).

4. A vibro hammer (1) according to claim 1, characterized by at least one first cover (18) which is mounted to the body holes (8) provided on one side of the transmission body (6) via a bolt.

5. A vibro hammer (1) according to claim 1, characterized by at least one second cover (19) which is mounted to the body holes (8) provided on the other side of the transmission body (6) via a bolt.

6. A vibro hammer (1) according to claim 1, characterized by at least one first collar (20) whose diameter is somewhat larger than the diameter of the transmission body (6) and which is mounted to the transmission body (6) from the side that is close to the first cover (18).

7. A vibro hammer (1) according to claim 1, characterized by at least one second collar (21) whose diameter is somewhat larger than the diameter of the stepped shaft (12) and which is mounted to the stepped shaft (12) from the side that is close to the second cover (19).

8. A vibro hammer (1) according to claim 1, characterized by at least one first gear (22) which is mounted to the periphery of the transmission body (6) by means of the first collar (20) and which rotates at the same velocity with the rotation velocity of the transmission body (6).

9. A vibro hammer (1) according to claim 1, characterized by at least one second gear (23) which is mounted to the stepped shaft (12) by means of the second collar (21) and which rotates at the same velocity with the rotation velocity of the stepped shaft (12).

10. A vibro hammer (1) according to claim 1, characterized by at least one oil delivery member (24), which, when the stepped shaft (12) is desired to be rotated more or less, enables the aperture at the end of the first oil line (14) or the aperture at the end of the second oil line (15) to be filled with oil by injecting oil to the first oil line (14) or the second oil line (15), and which thus enables the toothed piston (9) to move.

11. A vibro hammer (1) according to claim 1, characterized by the stepped shaft (12) which is mounted to the main body (2) by means of at least two second ball bearings (17) which enable it to rotate around its own axis.

12. A vibro hammer (1) according to claim 1, characterized by the toothed piston (9) which is mounted to the area on the stepped shaft (12) where there is the shaft tooth (13).

13. A vibro hammer (1) according to claim 1, characterized by the internal tooth (11) which, when the toothed piston (9) is mounted to the stepped shaft (12), is engaged with the shaft tooth (13).

14. A vibro hammer (1) according to claim 1, characterized by the first ball bearing (16) which is located on the stepped shaft (12) and enables the transmission body (6) to be kept around the stepped shaft (12).

15. A vibro hammer (1) according to claim 1, characterized by the body tooth (7), which is engaged with the external tooth (10) at the area where the transmission body (6) contacts the toothed piston (9).

16. A vibro hammer (1) according to claim 1, characterized by the first cover (18) which is mounted to the side surface of the transmission body (6) that is close to the toothed piston (9).

17. A vibro hammer (1) according to claim 1, characterized by the first gear (22), which is mounted to the transmission body (6) by means of the first collar (20), and has the same angular velocity with the angular velocity of the transmission body (6) and rotates synchronously with the transmission body (6).

18. A vibro hammer (1) according to claim 1, characterized by the second gear (23), which is mounted to the stepped shaft (12) by means of the second collar (21), and has the same angular velocity with the angular velocity of the stepped shaft (12) and rotates synchronously with the stepped shaft (12).

19. A vibro hammer (1) according to claim 1, characterized by the first gear (22) which contacts the set gear (G) provided on the upper weight set (3).

20. A vibro hammer (1) according to claim 1, characterized by the second gear (23) which contacts the set gear (G) provided on the lower weight set (4).

21. A vibro hammer (1) according to claim 1, characterized by the rotary oil delivery member (24), which delivers pressure oil to the first oil line (14) and enables to fill the aperture at the end of the first oil line (14) with oil, and thus moves the toothed piston (9) a little along the axis of the stepped shaft (12).

22. A vibro hammer (1) according to claim 1, characterized by the toothed piston (9) which rotates the stepped shaft (12) with an angular velocity that is a little greater than the angular velocity at which the transmission body (6) rotates.

23. A vibro hammer (1) according to claim 1, characterized by the second gear (23) which, upon rotation of the stepped shaft (12) a little faster, rotates the lower weight set (4) a little faster than the upper weight set (3) and thus enables the weights (U) at the lower weight set (4) to come to the same position with the weights (U) at the upper weight set (3).

24. A vibro hammer (1) according to claim 1, characterized by the rotary oil delivery member (24), which, after driving or extraction is performed, fills the area at the end of the second oil line (15) with oil, and thus moves the toothed piston (9) for the weights at the sets (3, 4) to be brought from the vibration state to balance state.
